(19) United States
(12) Patent Application Publication
(10) Pub. No.: US 2025/0138658 A1
(43) Pub. Date: May 1, 2025

(54) NDT (NON-DESTRUCTIVE TESTING) DATA COLLECTION SYSTEMS, KITS, PARTS, AND RELATED METHODS OF USE

(71) Applicant: Junlin Shao, Edmonton (CA)

(72) Inventor: Junlin Shao, Edmonton (CA)

(21) Appl. No.: 18/928,158

(22) Filed: Oct. 27, 2024

(30) Foreign Application Priority Data
Oct. 27, 2023 (CA) 3,217,929

(51) Int. Cl. G06F 3/038; G06F 3/0346

(52) U.S. Cl. CPC G06F 3/0383; G06F 3/0346; G06F 3/0386

(57) ABSTRACT

An NDT (non-destructive testing) data collection system has: an electronic pen; a position sensor configured to detect a three-dimensional position in space of a tip of the electronic pen; and a processor configured to receive signals from the position sensor and to output, in use, map data of an area of a substrate traced by the electronic pen. A method includes moving an electronic pen one or both over or around an area of interest on a substrate, in which the area of interest comprises an anomaly; and recording, to a computer readable medium, map data of the area of interest calculated by a processor using signals from a position sensor in the electronic pen.

### TECHNICAL FIELD

This document relates to NDT (Non-Destructive Testing) data collection systems, kits, parts, and related methods of use.

### BACKGROUND

The following paragraphs are not an admission that anything discussed in them is prior art or part of the knowledge of persons skilled in the art.

NDT processes are carried out on various substrates including pipelines, in the oil and gas industry. The typical process involves manually penning out a section of pipeline that has been tested and identified as having a defect, followed by one or both of repairing the defect and producing a report of the defect along with its location.

### SUMMARY

An NDT (non-destructive testing) data collection system is disclosed comprising: an electronic pen; a position sensor configured to detect a three-dimensional position in space of a tip of the electronic pen; and a processor configured to receive signals from the position sensor and to output, in use, map data of an area of a substrate traced by the electronic pen.

A method is disclosed comprising: moving an electronic pen one or both over or around an area of interest on a substrate, in which the area of interest comprises an anomaly; and recording, to a computer readable medium, map data of the area of interest calculated by a processor using signals from a position sensor in the electronic pen.

A method is disclosed of using an electronic pen configured to draw upon and digitally map an area on a surface, the electronic pen comprising: a body of the electronic pen, defining a housing, a writing end and a top end; a writing tip at the writing end of the electronic pen, which is connected to an ink tank; a plurality of optical tracing sets forming a circle around the writing tip, with each optical tracing set comprising: a laser light source; and an optical sensor; a signal processor and an accelerometer housed within the housing of the electronic pen; a control panel on the body of the electronic pen; and a data transfer system configured to send data to an external computing device.

In some cases, the methods and apparatuses may be used to produce a defect report. In some cases, the methods and apparatuses may be used to produce a repair report indicating either where repairs have occurred or should occur. Repairs may be validated by use of the system 10 or visual inspection. A tip of the pen may be changeable and reusable.

In various embodiments, there may be included any one or more of the following features: The position sensor comprises a tip contact sensor. The processor is configured to produce the map data from signals that corresponds to the tip being in contact or close proximity with the substrate. The tip contact sensor comprises one or more of a pressure sensor or a proximity sensor. The position sensor comprises one or more optical tracing sets. The one or more optical tracing sets comprise a plurality of optical tracing sets arranged at different angular positions about a periphery of the tip of the electronic pen. The one or more optical tracing sets each comprise: a laser source; a lens; and an optical sensor. The processor is configured to determine an orientation of the electronic pen in space from signals from the position sensor. The position sensor comprises one or more of an accelerometer and a gyroscope. The electronic pen comprises an ink pen. A display may be configured to display the map data. A computer readable medium may be connected to store the map data from the processor. The signals received from the position sensor comprise coordinate information. Coordinate information comprises coordinates measured relative to a defined reference; and the processor is configured to produce the map data relative to the defined reference. The processor is configured to store or display the map data in association with the defined reference. The processor is mounted as part of a control panel with a housing separate from the electronic pen, with a wireless transceiver for communicating wirelessly with the electronic pen and the position sensor. Recording map data of an area of interest on a substrate using the NDT data collection system. The substrate comprises a pipeline. Prior to recording, carrying out an NDT process on the substrate to identify the area of interest as containing the anomaly. The anomaly comprises a defect in or on the substrate. After recording, repairing the defect in the substrate. Moving the electronic pen further comprising marking the area of interest with the electronic pen. Before moving the electronic pen one or both over or around the area of interest, calibrating the movement of the electronic pen, by moving the electronic pen over a reference part of the substrate and using the processor to correlate the movement with measured dimensions of the reference part. Using the processor, inputting, compiling, or detecting dimensional features of the substrate and associating the map data with such dimensional features. The processor compiles or detects the dimensional features by one or more of: accessing a database of dimensional features; or analyzing one or more images of the substrate or dimensional features. The database is a cloud-based database. Using the processor, to determine a repair strategy for the anomaly and associate the map data with information on the repair strategy.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is cross-sectional view of an NDT (non-destructive testing) data collection system, comprising an electronic pen with position sensors and a built-in control panel.

FIG. 2 is a line diagram of an optical tracing set of the NDT data collection system of FIG. 1.

FIG. 3 is a perspective view of an NDT data collection system in kit form with a separate control panel.

FIG. 4 is perspective view of the pen of the NDT data collection system of FIG. 1 drawing on a substrate.

FIGS. 5 and 6 are graphical representations of data points from a series of optical tracing sets about the tip of the pen from the NDT data collection system of FIG. 1, illustrating data from the pen being oriented 90 degrees relative to the substrate (FIG. 6) and at an acute or obtuse angle relative to the substrate (FIG. 7).

FIG. 7 is a perspective view of a pipeline with an anomaly (such as a defect), which has been marked by the NDT data collection system of FIG. 1.

FIG. 8 is a graphical representation of map data collected by the NDT data collection system of FIG. 1.

FIG. 9 is a screenshot of a computer screen displaying the map data collected by the NDT data collection system of FIG. 1.

FIG. 10 is tip end view of the NDT data collection system of FIG. 1.

FIG. 11 is a graphical representation of the NDT data collection system of FIG. 1 when it is set by a 3D (three dimensional) accelerometer.

FIG. 12 is a screenshot of the control panel of the NDT data collection system of FIG. 3.

FIG. 13 is a block diagram of an example method of using the NDT data collection system of FIG. 1.

FIG. 14A is a block diagram of an example method of 3D modelling of a pipeline, carried out by inputting various pipeline information into the NDT data collection system of FIG. 1. This procedure could also be carried out by accessing information from a database from a company, such as an Oil & Gas company, for example containing information on pipeline or other infrastructural dimensions.

FIGS. 14B-14E are a series of perspective views of a 3D model of a pipeline generated at the first, second, third, and fourth stages, respectively, of the 3D modelling method of FIG. 14A.

FIG. 15A is a block diagram of an example calibration method carried out using the NDT data collection system of FIG. 1.

FIGS. 15B-15I are a series of perspective views of a pipeline that is being interacted with using the pen of the NDT data collection system of FIG. 1 to carry out the various respective stages of the calibration method of FIG. 15A.

FIG. 16A is block diagram of an example procedure for marking out an anomaly of a pipeline using the NDT data collection system of FIG. 1.

FIG. 16B is a perspective view of a pipeline with an anomaly.

FIGS. 16C-16E are a series of perspective views of the pipeline of FIG. 16B marked in the respective stages of the method of FIG. 16A.

FIG. 17A is a block diagram of an example method for repairing an anomaly of a pipeline, for example using a grinding method.

FIGS. 17B-17C are a series of perspective views illustrating the marking out and selecting of a reference stage of the method of FIG. 17A.

FIG. 18A is block diagram of an example method of repairing an anomaly of a pipeline by adding a sleeve or cutting out and replacing a section of the pipeline.

FIGS. 18B-18D are a series of perspective views of the method of FIG. 18A carried out to repair the pipeline with a sleeve.

FIGS. 18E-18G are a series of perspective views of the method of FIG. 18A carried out to repair the pipeline by cutting out and replacing a section of pipeline.

FIG. 19 is a perspective view of a portable case for storing and transporting the NDT data collection system of FIG. 1.

FIGS. 20-21 are side elevation views of the pen of the NDT data collection system being housed within the portable case of FIG. 19, between opposed plates that may be used to calibrate the pen while the pen is stored.

FIG. 22A is a block diagram of an example method of calibrating the pen of the NDT data collection system of FIG. 1 while the pen is retained within the portable case of FIG. 19.

FIG. 22B is a side elevation view of the pen of the NDT data collection system being housed within the portable case of FIG. 19 before calibration has occurred.

FIG. 22C is a side elevation view of the pen of the NDT data collection system being housed within the portable case of FIG. 19 during calibration.

FIG. 22D is a side elevation view of the pen of the NDT data collection system being housed within the portable case of FIG. 19 after calibration is complete.

FIG. 23A is a plan view of a printed circuit board and position sensors of an example pen of the NDT data collection system of FIG. 1.

FIG. 23B is a close-up view of the area denoted in dashed circular lines in FIG. 23A.

FIG. 23C is a simplified view of an example arrangement and operation of the position sensors of FIG. 23A.

FIGS. 24-28 are plan views of a section of pipeline that has undergone a grind repair of an anomaly of the pipeline, with each figure illustrating a different original location for the anomaly that has been repaired.

FIG. 29 is a side elevation view of another embodiment of an NDT data collection system with a camera array mounted to a distal end of an electronic pen.

FIG. 30 is a bottom plan view of the camera array of FIG. 29.

FIG. 31 is a perspective view of the NDT data collection system of FIG. 29 being used to mark an anomaly of a surface.

### DETAILED DESCRIPTION

Immaterial modifications may be made to the embodiments described here without departing from what is covered by the claims.

Non-destructive testing (NDT) is a methodology employed across various industries to evaluate the integrity, quality, and safety of materials, components, and structures without causing any damage or alteration to the tested object. NDT techniques use a diverse range of technologies such as ultrasound, X-rays, magnetic particles, eddy currents, and visual inspection, among others, to detect flaws, defects, or irregularities in materials or products. By providing valuable insights into the structural integrity and performance of assets, NDT ensures the reliability of infrastructure, manufacturing processes, and the overall safety of end-users. NDT is non-invasive and reduces downtime, minimizes costs, and enhances the quality control process, making it an indispensable tool for various industries such as aerospace, automotive, construction, and oil and gas.

The most commonly used types of NDT include Ultrasonic Testing, Radiographic Testing, Magnetic Particle Testing, Dye Penetrant Testing, Eddy Current Testing and Visual testing. Ultrasonic Testing employs high-frequency sound waves to detect flaws, thickness, and material properties. Radiographic Testing uses X-rays or gamma rays to penetrate an object and create an image revealing internal defects. Magnetic Particle Testing and Dye Penetrant Testing are widely used for detecting surface cracks and discontinuities by applying magnetic fields or colored liquids, respectively. Eddy Current Testing (ET) relies on electromagnetic induction to examine conductive materials for cracks and flaws. Visual Testing (VT) is a straightforward but essential method involving visual inspection for surface imperfections. These diverse NDT all techniques play a role in ensuring the quality and safety of a wide range of products and structures.

The oil and gas industry is a multifaceted sector that encompasses the exploration, extraction, refinement, and distribution of hydrocarbon resources, including crude oil and natural gas. It plays a pivotal role in meeting the world's energy demands, powering transportation, heating, and electricity generation. The industry relies on sophisticated technologies for locating and drilling wells, often in challenging environments, both onshore and offshore. Once extracted, the raw materials undergo complex processing at refineries to produce a wide range of products, from gasoline and diesel fuel to petrochemicals. However, the oil and gas industry faces a multitude of challenges, including environmental concerns, fluctuating market prices, geopolitical issues, and the transition toward cleaner and more sustainable energy sources. As the world evolves toward renewable energy and carbon reduction goals, the oil and gas sector is undergoing a transformation, focusing on innovation and efficiency while addressing environmental and social responsibility concerns.

NDT plays a critical role in the oil and gas industry, ensuring the integrity and safety of equipment and infrastructure. One primary application is the inspection of pipelines, where techniques like Ultrasonic Testing and Magnetic Flux Leakage are used to detect corrosion, wall-thinning, and defects in the pipeline walls. NDT is also essential in the examination of pressure vessels, tanks, and offshore platforms to identify stress corrosion cracking, weld integrity, and structural flaws. Moreover, NDT is instrumental in assessing the condition of drilling components, such as drill pipes and casings, to prevent catastrophic failures during drilling operations. The oil and gas industry relies on NDT to comply with safety regulations, reduce downtime, and extend the operational lifespan of critical assets, ultimately ensuring the continuous and secure supply of energy resources.

As above, NDT processes play a crucial role in ensuring the safety and integrity of pipelines within the oil and gas industry. The continuous operation of pipelines is paramount to the oil and gas industry. NDT techniques such as ultrasonic testing, radiography, magnetic particle testing, and eddy current testing are used to assess the condition of pipelines without causing damage. These methods may allow for the detection of defects, corrosion, and structural weaknesses, without damaging the pipeline structures themselves, enabling timely maintenance and repair to be scheduled to prevent costly and environmentally damaging leaks or failures. By conducting routine NDT inspections, the oil and gas industry can maintain the reliability of its vast pipeline networks and reduce the risk of catastrophic incidents, thereby safeguarding both the environment and public safety.

In the oil and gas industry, NDT results must be carefully recorded and reported to parties of interest as part of the proper maintenance and operation of infrastructure. Comprehensive documentation and record-keeping are essential for compliance, safety, and quality control. NDT results are typically recorded through a combination of digital and hardcopy records, including photographs, videos, and detailed written reports. These records capture the testing process, findings, and any anomalies detected. Furthermore, data is often stored electronically in dedicated NDT databases for long-term analysis and trend monitoring, enabling companies to track the condition of their infrastructure over time. Proper recordation of NDT results not only supports regulatory compliance but also aids in making informed decisions about maintenance, repairs, and the overall health of the pipelines and equipment, ensuring long-term reliability and safety. Reporting processes are typically carried out by external consulting firms or in-house experts.

Part of the process of carrying out NDT processes and repairs in the oil and gas industry involves the manual marking of structures (substrates) to indicate the location of detected anomalies (areas of interest). The manual marking of anomalies on pipelines is a crucial step in the NDT process for same. Skilled technicians, using tools like paint, chalk, or other suitable markers, will physically mark any detected defects or anomalies on the pipeline's surface. These markings are placed precisely to indicate the location and extent of the issue, ensuring that subsequent inspection or repair teams can easily locate and address the problem. The marked locations may refer to both external defects (defects on the outside of the structure) and internal ones (defects on the inside of structures, typically not observable by the naked eye from outside the structure). An NDT technician will typically supplement the physical markings of a structure with detailed notations in an inspection report. These reports include information about the type of anomaly, its size, shape, orientation, and its distance from identifiable reference points, all of which contribute to an accurate assessment of the pipeline's condition. In some cases, photographs and digital records may also be used to further document the markings and the anomalies for comprehensive records and future reference during maintenance or repair procedures. Accurate manual marking and recording processes are observed in the industry in order to ensure the safe and efficient repair and operation of pipelines in the oil and gas industry.

Electronic pens and styluses have revolutionized the way users interact with digital devices. These tools, often equipped with touch-sensitive tips or advanced pressure-sensitive technology, enable users to draw, write, and navigate on smartphones, tablets, and touchscreen computers with precision and ease. They may come in various forms, including passive and active styluses, each offering distinct advantages. Passive styluses are simple and do not require power, while active styluses can offer features like palm rejection and advanced pressure sensitivity for a more natural writing or drawing experience. Some electronic pens and styluses are equipped with customizable buttons, allowing users to quickly access functions like erasing or changing pen thickness. Electronic pens and styluses have found applications in creative fields, note-taking, digital art, and precise data input, making them useful for professionals and enthusiasts alike. The versatility of a stylus or pen may bridge the gap between traditional analog and digital worlds, enhancing productivity and expression in the creative fields.

3D (3-dimensional) position sensors are advanced technological devices that play a pivotal role in various industries, from robotics to virtual reality. 3D sensors may use a combination of technologies such as ultrasonic, laser, or electromagnetic fields to precisely determine the position and orientation of objects or devices in three-dimensional space. Position sensors are used for tasks like object tracking, motion control, and gesture recognition, enabling precise movement and interaction in a wide range of applications. 3D position sensors have a spectrum of uses, including in gaming controllers, medical equipment, autonomous vehicles, and industrial automation, where their accuracy and real-time data feedback ensure safe and efficient operations. The versatility and expanding capabilities of 3D position sensors continue to drive innovation in numerous fields.

Digital handwriting and pen tools, when integrated with 3D position sensors, offer a transformative way to bridge the gap between traditional and digital writing experiences. These sensors enable the precise tracking of the pen's movement in three-dimensional space, allowing for accurate re-creation of handwritten content on digital surfaces. This technology is particularly beneficial for creative professionals, note-takers, and artists, as it captures the nuances of handwriting, through sensors that can detect pressure sensitivity and stroke variation. Additionally, the use of 3D position sensors enhances the interaction with virtual reality environments, as users can draw or write in mid-air, opening up new possibilities for immersive experiences. By fusing the tactile familiarity of handwriting with the precision and versatility of digital tools, these integrated systems are redefining how we engage with and create content in the digital age, offering a seamless and expressive transition between analog and digital realms.

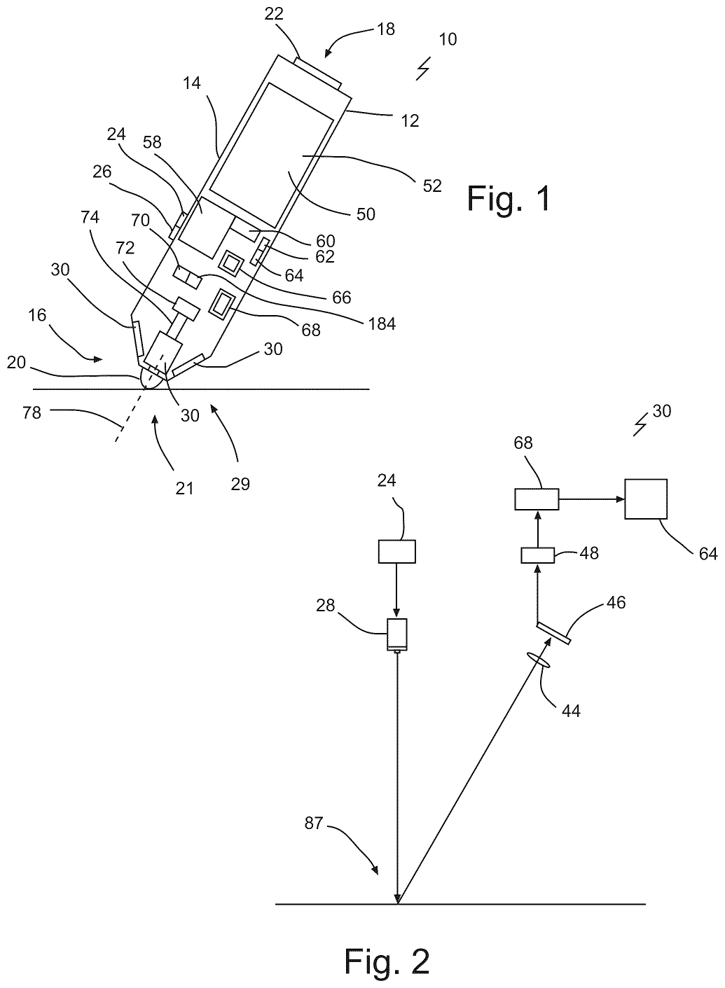

Referring to FIGS. 1-4 and 7, an NDT (non-destructive testing) data collection system 10 is disclosed. The system 10 may comprise an electronic pen 12. The electronic pen 12 may define a cylindrical body 14 with a writing end 16 and a distal end 18 (distal relative to the writing end). The electronic pen may form a tip 20 at the writing end 16. The system 10 may comprise a position sensor 29 or a plurality of sensors 29. The position sensor 29 may be configured to detect a three-dimensional position in space of the tip 20 of the electronic pen 12. The system 10 may comprise a processor 66 configured to receive signals, such as coordinate information, from the position sensor 29. The processor 66 may be configured to output, in use, map data 136 of an area of the substrate 87 traced by the electronic pen 12. In use, the electronic pen 12 may be moved one or both over or around an area of interest, such as containing or bounding an anomaly 118, on a substrate 87. The area of interest may have already been identified by an NDT (non-destructive testing) process as comprising the anomaly 118. The electronic pen 12 may be used to record map data 136 of an area of interest on the substrate 87, for example an anomaly 118 on a pipeline 88. The processor 66 may record, to a computer readable medium 62, map data 136 of the area of interest calculated by the processor using signals from the position sensor in the electronic pen. After the anomaly 118 is recorded using the system 10, the anomaly 118 may be repaired.

Referring to FIG. 1, the electronic pen 12 may have various components and features. The pen 12 may comprise a power switch 22, which may be used to turn the pen 12 on and off. The pen may comprise a battery 60, which may be rechargeable, for example via a charging coil 58 or other charging mechanism. The processor 66 may include a picture processor 68. The pen 12 may comprise a writing switch 24, which when pressed may cause the pen 12 to begin tracking the tip 20, and when unpressed or released, may cease tracking or otherwise send signals indicate whether the tip should be tracking or not as selected by the user. The pen 12 may comprise a sensitivity dial 26 or other input, which may increase or decrease the sensitivity of the position sensor 29 as desired. The pen 12 may comprise one or more other sensors to track the location of the tip 20, such as a gyroscopic sensor 70 and a 3D accelerometer 184. The tip 20 may be removable and replaceable. The pen 12 may be sealed, for example to render the tip weatherproof, to allow for use of the pen 12 in extreme weather conditions. A wireless (or wired) transceiver 64 may be used to transmit map data 136 and receive data from external devices.

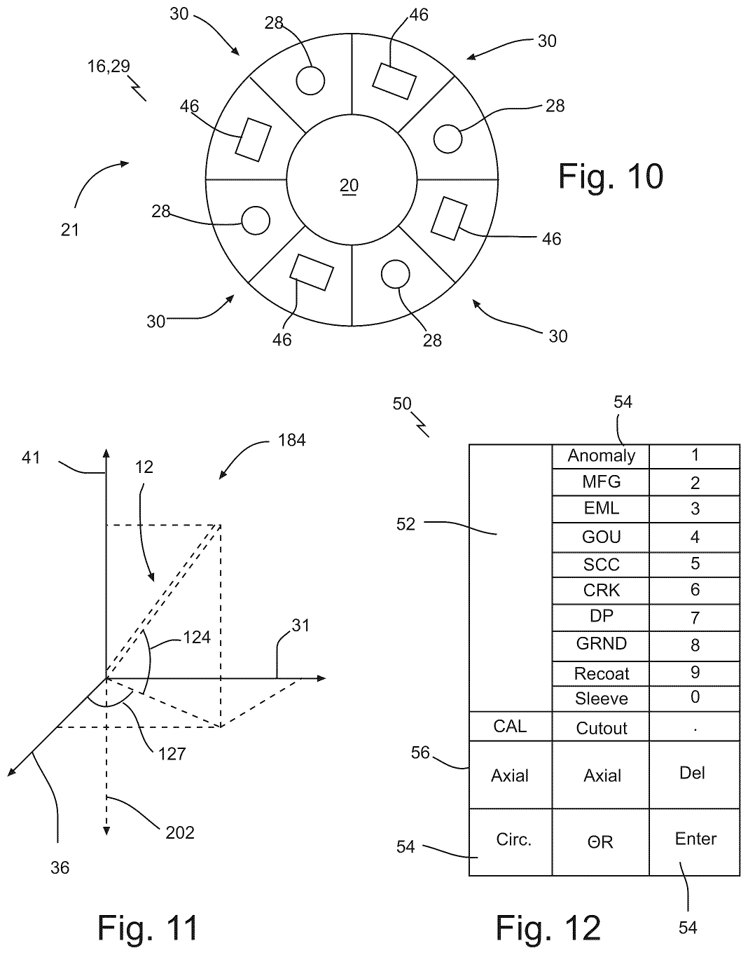

Referring to FIGS. 1-4, 10 and 23C, the position sensor 29 may comprise a tip contact sensor 21. The tip contact sensor 21 may be configured to determine when the tip 20 of the electronic pen 12 is touching (or in close proximity to) the substrate 87. The substrate 87 may be any surface that has undergone NDT or a subject candidate for NDT, for example a pipeline 88, a rail of a railway line, a storage tank, or any other suitable substrate. The processor 66 may be configured to produce the map data 136 from signals, such as coordinate information, that corresponds to the tip 20 being in contact or close proximity with the substrate 87. The position sensor may send a continuous stream of data (signals) to the processor, in which case the processor determines whether the data represents the tip being in contact with the substrate and hence the data should form part of the map of the area of interest, and/or the position sensor may send discrete data corresponding only to data when the tip is in contact with the area of interest, in which case the processor can store all of the data received by the position sensor. The tip contact sensor 21 may comprise a pressure sensor 72. The tip contact sensor 21 may be configured to use one or more of the position sensor 21 and the pressure sensor 72 to determine if the tip 20 of the electronic pen 12 is in contact or close proximity with the substrate 87. With a pressure sensor, the pressure sensor may be configured to send signals to the processor that represent that a pressure on the tip beyond a threshold pressure has been detected, indicative of the tip being in contact with the substrate.

Proximity sensors are essential components in various industrial applications, designed to detect the presence or absence of objects within a specific range without physical contact. These sensors operate using a range of technologies, such as inductive, capacitive, ultrasonic, or infrared, to measure the proximity of an object and provide accurate distance or position information. Proximity sensors find widespread use in automation, robotics, and manufacturing processes for tasks like object detection, material handling, and position control. They offer benefits such as high reliability, rapid response times, and non-intrusive operation, making them crucial for enhancing efficiency and safety in a wide array of industrial settings. Proximity sensors continue to evolve with technological advancements, contributing to the optimization of modern industrial processes.

Proximity sensors come in several types, each with its unique operating principles and applications. Inductive proximity sensors utilize electromagnetic coils to detect the presence of metallic objects within their proximity by generating eddy currents. Capacitive proximity sensors, on the other hand, use changes in capacitance to identify the presence of both metallic and non-metallic materials, making them versatile in various industrial applications. Ultrasonic proximity sensors emit sound waves and calculate the distance to an object by measuring the time it takes for the sound waves to return. They are suitable for detecting a wide range of materials, regardless of their properties. Infrared proximity sensors use infrared light to detect nearby objects, with applications in position tracking and object presence detection.

Laser proximity sensors are a specialized type of proximity sensor that employs laser technology to detect the presence or distance of objects within their operational range. These sensors emit a focused laser beam, and their advanced optics and detectors enable precise and rapid measurements. Laser proximity sensors may offer high accuracy and fine-resolution distance measurements. Laser proximity sensors are commonly used in industrial automation, robotics, and precision manufacturing, where they can detect and monitor the position of objects, even in challenging environmental conditions. Their non-contact nature, ability to work at longer distances, and resistance to factors like dust, dirt, or moisture make them ideal for tasks like object positioning, conveyor control, and quality control in various industries, contributing to enhanced operational efficiency and product quality.

Referring to FIGS. 1-2, 4-6, 10, and 23C, the position sensor 29 may comprise one or more optical tracing sets 30. An optical tracing set 30 may be an example of a proximity sensor. The one or more optical tracing sets 30 may each comprise one or more of a laser source 28, a lens 44 and an optical sensor, such as one or more of a light sensor 46/optical detector 48. Other optical tracing sets 30 may be used that incorporate light other than lasers. The one or more optical tracing sets 30 may comprise a plurality of optical tracing sets 30, which may be arranged at different angular positions about a periphery of the tip 20 of the electronic pen 12, such as at ninety-degree angular spacings relative to one another as shown in the example of FIGS. 5-6 and 10. The position sensor 29 may be configured to use the one or more optical tracing sets 30 to determine when the tip 20 is in contact or close proximity with the substrate 87. The laser source 28 of the optical sets 30, such as a vertical-cavity surface-emitting laser 192 (VCSEL), may be reflected off of the substrate 87 and detected by the light sensor 46, such as a complementary metal oxide semiconductor 190 (CMOS). The reflected laser source 28 may be focused onto the light sensor 46 by the use of one or more lenses 44. One or more optical filters 274 may be used to process the light. The detection of the laser source 28 by the light sensor 46 may indicate to the system 10 that the tip 20 is in contact or close proximity with the substrate 87. The data received from the plurality of optical tracing sets 30, for example the collected points 82 each representing data from an individual tracing set 30, may be interpreted by the processor 66 to determine or otherwise calculate the location of the tip, for example the data may be extrapolated to determine a calculated point 80 of the tip 20. The calculated or extrapolated point 80 may represent the point where the tip 20 contacts or is in close proximity with the substrate 87. The calculated points 80 may be used to form the map data 136. The figures provided demonstrate the tracking logic of the device, with the angle 124 between the device and the x-y plan, 4 optical sets collect data from 4 points around the tip as shown at the bottom. The processor and software in the system may calculate and locate the center of the tip. FIGS. 5 and 6 show how the 4-point data looks like when angle theta is equal to 90 degrees and not equal to 90 degrees. The calculation of the tip may be determined by applying the example equation: the opposite optical sets data are set to X1, X2; Y1, Y2. The location of the tip is: ((X2−X1)/2+X1, (Y2−Y1)/2+Y1). The calculation would thus provide new X and Y coordinates from the reference start. The optical sets may collect and calculate data along the drawing and then transfer the data to a laptop or other computing device.

Sensors exists that are designed to detect the orientation of an object in space. Several types of sensors serve this purpose. Inertial Measurement Units (IMUs) incorporate accelerometers and gyroscopes to measure an object's linear acceleration and angular velocity, enabling calculation of its orientation. Magnetometers, which detect changes in magnetic fields, are used in combination with accelerometers and gyroscopes to provide absolute orientation information, especially for applications like navigation. Another class of sensors known as inclinometers or tilt sensors directly measures the inclination or tilt of an object relative to the Earth's gravitational field. These sensors are essential in applications like construction and geophysics. Optical sensors, like cameras and image sensors, can also be used to determine an object's orientation by analyzing visual cues, while GPS sensors provide orientation information concerning an object's movement in relation to Earth's coordinates. These diverse sensor types offer various trade-offs between accuracy, cost, and application-specific requirements, making them essential tools for monitoring and controlling the orientation of objects in space.

Referring to FIGS. 1, 4-6, 11 and 15A-15I, the processor 66 may be configured to determine an orientation of the electronic pen 12 in space from signals from the position sensor or sensors 29. The position sensor 29 may comprise one or more of an accelerometer 184 and a gyroscope, such as a gyroscopic sensor 70. An angular orientation of the pen 12 may be determined by the 3D accelerometer 184. The angular orientation may be defined as one or more angles relative to the substrate, or the earth, for example the angle 124 between the substrate 87 (x-y plane in the example shown) and the pen axis 78 of the pen, and the angle 127 between the position 125 of the pen 12 projected onto the x-y plane and the y-axis 36. The 3D accelerometer 184 may detect movement of the pen 12 along one or more of the x-axis 31, a y-axis 36 and a z-axis 41. The orientation of the pen 12 may be used by the processor 66 relative to a known reference or an absolute reference on the Earth, and in conjunction with data regarding the tip of the pen 12, to determine the exact position and orientation of the pen 12.

Referring to FIGS. 1 and 7-8, the electronic pen 12 may be configured to mark the substrate 87 in use. The pen 12 may comprise an ink pen. The pen 12 may have a fluid tank 74 or other reservoir, which may hold a suitable fluid for marking the substrate 87, for example, ink, chalk, paint or various other fluids. The electronic pen 12 may be used for form a marking 122 around an areas of interest on the substrate, for example to delineate the detected location of various anomalies 118 on a pipeline 88 or other substrate 87. The ability of the pen 12 to create a marking 122 may be used to denote an anomaly 118 (for example a profile of a defect or the location thereof) may make it relative straightforward for locating the detected anomaly in subsequent visual inspections of the substrate 87, such as part of a repair process. For example, an NDT company may arrive on site on a certain day, marking up the pipeline or other substrate with markings indicative of anomalies that require repair, and on the same day or a subsequent day, the same NDT company, or a repair company (for example in the case of sleeve and cut-out repairs) may arrive on site to fix the various anomalies, identifying the location of each by visual inspection without a need to repeat the NDT process.

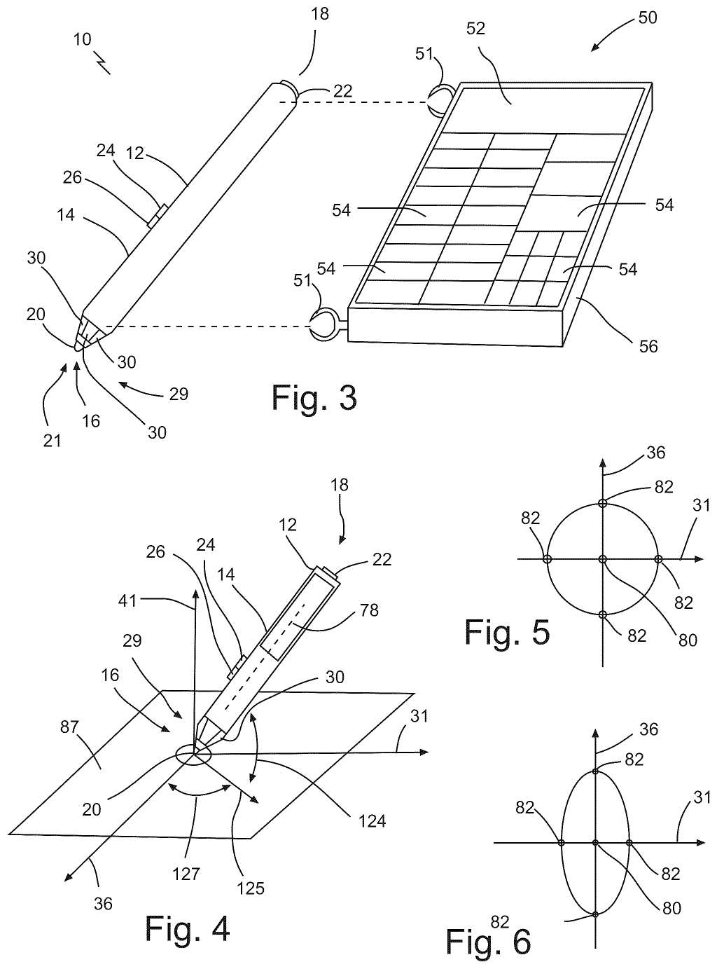

Referring to FIGS. 1, 3, and 12, the electronic pen 12 may include suitable controls, such as a suitable control panel 50. The control panel 50 may comprise various user interface (UI) inputs, such as buttons 54. The panel 50 shown in the illustrated example is a touchscreen, although other forms of panels 50 may be used. The buttons 54 or other inputs may be used to enter various data that may be used to analyze or characterize the substrate, for example to identify what type of anomaly 118 is associated with the map data 136, for example one or more of a manufacturing defect (MFG), external metal loss (EML), gouge (GOU), stress corrosion cracking (SCC), crack (CRK), depth (DP), and grind (GRND). The buttons 54 or other inputs may be used to suggest or permit the user to indicate the type of repair needed to repair the anomaly 118, for example recoat, sleeve, and cutout. The control panel 50 may comprise a screen (an example of a display 52), such as a touch screen. The user may manually input or confirm data through the control panel 50. Data pertaining to the anomaly 118 that is not collected by using the electronic pen 12 may be added using the control panel 50, for example the type of anomaly 118, the depth of the anomaly 118, and the type of repair that is needed to correct the anomaly 118. The control panel 50 may be used to verify data either recorded or suggested by the processor 66. The control panel 50 may be integrated into the pen 12 (FIG. 1). The control panel 50 may be external from the pen 12 (FIG. 3), for example the control panel 50 may have separate housing from the pen 12, such as an external housing 56. In some cases, the control panel 50 may be a separate computer, such as a tablet or mobile phone, and may run suitable software to execute the respective functions of the processor 66, such as via suitable application-specific software. The control panel 50 may assist the user in tabulating data and creating reports. Through the use of the control panel 50 and the collection of map data 136, the electronic pen 12 may reduce the amount of time needed to create reports of anomalies 118.

Referring to FIGS. 1, 9 and 23A, the system 10 may be configured to output and store data, such as map data 136. The system 10 may store such data on a computer readable medium 62. Computer-readable mediums, often referred to as storage media or storage devices, are physical or digital storage mediums capable of storing data in a format that can be read and processed by a computer. These mediums encompass a wide range of devices and formats, including hard drives, solid-state drives, optical discs, USB drives, magnetic tapes, and memory cards. They serve as repositories for software, files, and data, allowing computers to access, retrieve, and manipulate information as needed. The choice of a computer-readable medium depends on factors like data capacity, access speed, portability, and longevity, with each medium offering a specific balance of these attributes to suit various storage and data retrieval requirements in the world of computing. The computer readable medium 62 may be connected to store one or both the map data 136 and coordinate information form the processor 66. Coordinate information may include the collected points 82 and the calculated points 80, along with orientation information, or may include other data as provided by the position sensors.

Referring to FIGS. 1, 3, 8, 9, and 12, the system 10 may incorporate or interface with a suitable display 52. The electronic pen 12 may comprise be configured to output or connect to a suitable display 52 configured to output the map data 136. The display 52 may form part of a control panel 50 of the system 10 (FIGS. 1, 3, 12), or may be a separate unit apart from the control panel 50 (FIGS. 8-9). The display 52 may form part of a computing system, such as a tablet or mobile phone, and may have a wired or wireless connection to the processor 66 or panel 50.

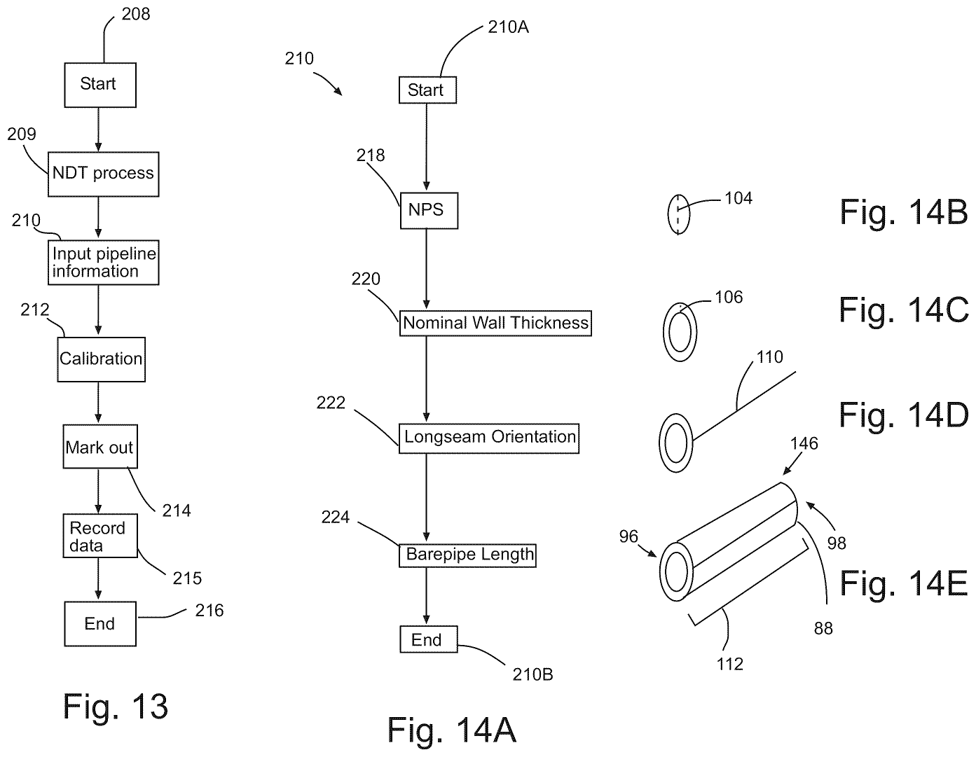

Referring to FIG. 13, an example method of using the NDT data collection system 10 is disclosed. The method begins at a start stage 208. The method may involve calibrating the movement of the pen 12. An NDT process may be carried out in a stage 209, for example to identify the presence of an anomaly 118 on the substrate. Information about the specific pipeline 88 may be entered into the system 10 at stage 210. The calibration may be carried out in a stage 212. The anomaly 118 of the pipeline 88 may be marked at stage 214. Map data of the anomaly 118 may be recorded in a stage 215. The method ends at an end stage 216.

Referring to FIGS. 14A-14E, an example method of inputting pipeline information (stage 210) is illustrated. The method may be used to create a 3D model 146 of a pipeline 88. In some cases, the information may be entered by the user manually, for example after taking detailed measurements or consulting design documents, and in other cases, the information may be inputted using one or sensors, such as the pen 12 to input the data. In other cases, the information may be obtained from the company or a database that stores dimensional and other information on the company's infrastructure. In an example of the latter, a data collection company or other person may store such information in a database such as a cloud-based storage system, and that may be accessed as needed by remote mechanism such as by using application software, API (application programming interface) or browser software to interface with the database. The pipeline or other information, and the company information may be extracted by the system from the Oil & Gas Company's records (for example another database) by cloud or software that automatically or on-demand accesses such database to pull information over to the user for use in the data collection system. The 3D model 146 may be generated using various information regarding the specific section of pipeline 88, for example nominal pipe size (NPS) 104, nominal wall thickness (NWT) 106, longseam orientation 110 and barepipe length 112. The 3D modelling process may begin with a start stage 210A. The NPS 104 may be input into the system 10 at stage 218. The NWT 106 may be input into the system 10 at stage 220. The longseam orientation 110 may be input into the system 10 at stage 222. The barepipe length 112 may be input into the system 10 at stage 224. The method ends at end stage 210B.

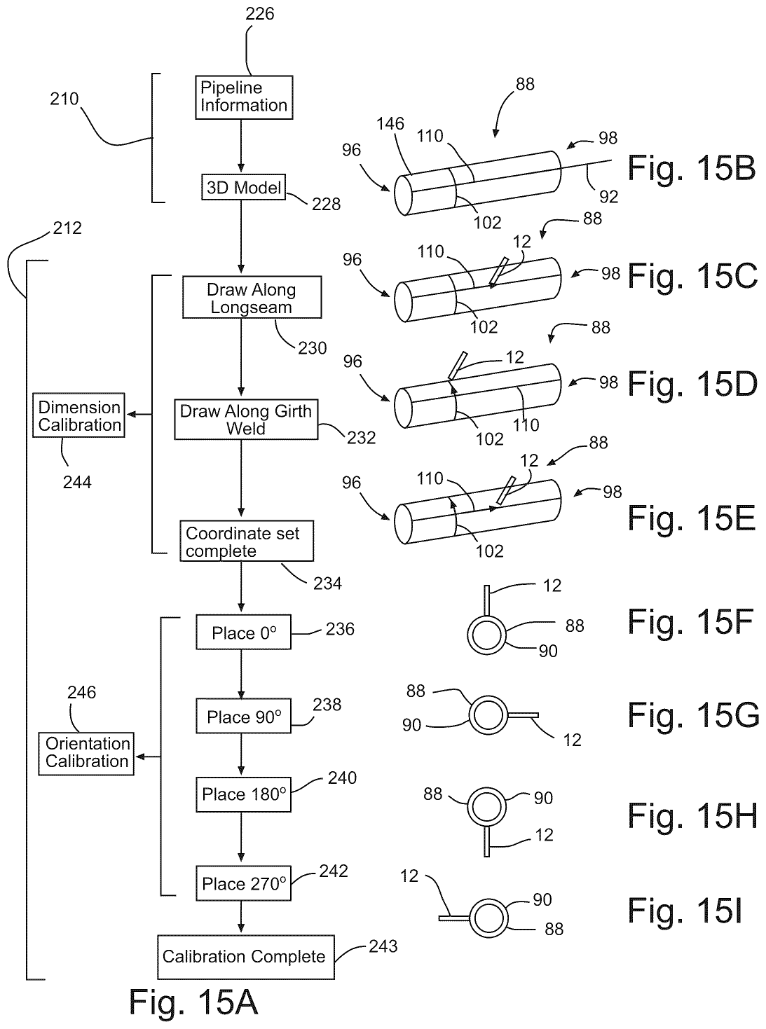

Referring to FIGS. 9, 13, 14A-14E and 15A-15I, the pen 12 may be calibrated prior to recording data on any area of interest. Calibration may be carried out before moving the electronic pen one or both over or around the area of interest (to record the area of interest). Calibration may involve moving the electronic pen over a reference part of the substrate and using the processor to correlate the movement with measured dimensions of the reference part. This way, once calibrated, the subsequent movements of the pen tip may be correlated to the calibrated movements, making it possible to interpret the sensor signals from the position sensor as corresponding to relative measurable distances and orientations (positions) of the pen tip in space. Stage 210 is broken down in FIG. 15A as containing two stages 226 and 228. The pen calibration may be carried out in order to form an accurate 3D model 146 in the software interface 144. The 3D model may be used as a backdrop over which the map data that is ultimately calculated may be overlaid and understood. The 3D model 146 may be based off of information regarding the specific section of pipeline 88, which may be entered at stage 226. The software interface 144 may generate the 3D model in stage 228, and may display the 3D model 146 on an external display 52, along with a table 147 of the map data 136. The 3D model 146 may display a first and second end 96 and 98 of a section of the pipeline 88.

Referring to FIGS. 15A-15I, stage 212 (calibration) may be carried out, for example as a series of stages as shown. A dimension calibration stage 244 may be carried out, for example as a series of stages. The process of dimensionally calibrating the electronic pen 12 may comprise one or more of an axial step, a circumferential step and an orientation step. In a stage 230, the axial step may comprise using the pen 12 to draw along a longseam (L/S) 110 of the pipeline 88. The circumferential step may comprise using the pen 12 to draw along a girth weld 102 of the pipeline 88, for example at stage 232. The dimension calibration step may ensure that the 3D model 146 comprises accurate dimensions of the pipeline 88. Based on the input, the coordinates of the 3D model may be set, for example at stage 234. An orientation calibration stage 246 may be carried out, for example as a series of stages. The orientation step may comprise placing the pen 12 on the surface 90 of the pipeline 88 at one or more different angular orientations, such as 0° (stage 236), 90° (stage 238), 180° (stage 240) and 270° (stage 242), about the axis of the pipeline, for example relative to the top of the pipeline 88 as shown. The method may be completed at stage 243. The orientation calibration may be required to ensure that the anomaly 118 is rendered at the correct orientation on the 3D model 146. In order to form an accurate 3D model 146, various pipeline 88 information may be entered using the control panel 50 in the above discussed stages, or using the pen 12. Pipeline 88 information may include one or more of nominal pipe size (NPS) 104, nominal wall thickness (NWT) 106, longseam orientation 110 and barepipe length 112. The 3D-accelerometer 184 may be used for axial and circumferential calibration. The gyroscopic sensor 70 may be used for angular and orientation measurement. Other sensors and sensor data may be used. Referring to FIG. 9, an example of the 3D model 146 is illustrated as being displayed on display 52, along with various respective information derived from the modelling and other stages. OR is understood to mean orientation, and Assoc is understood to mean associated anomalies.

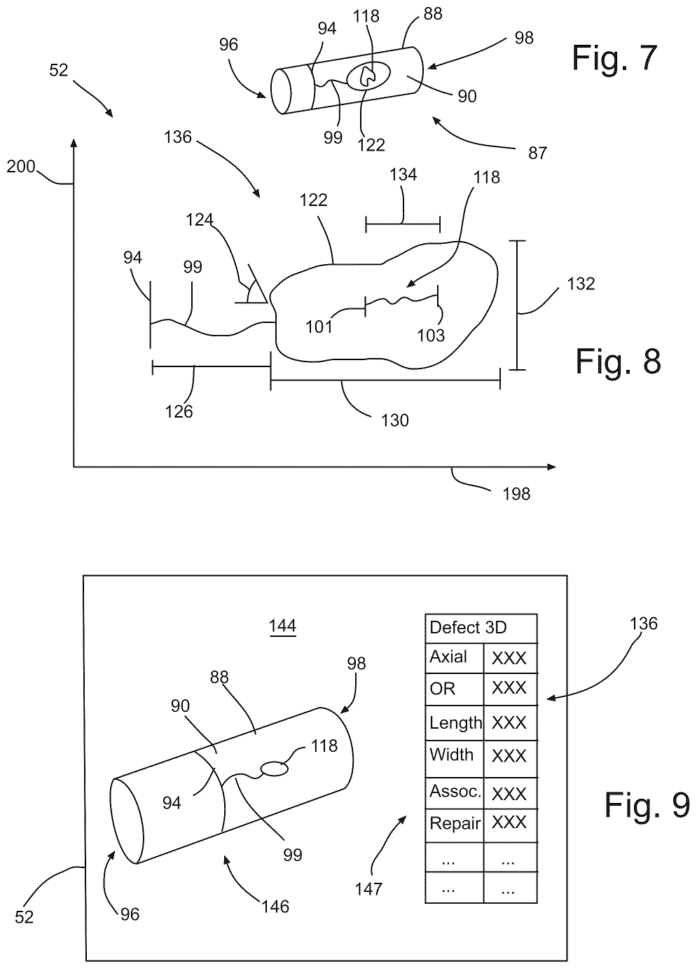

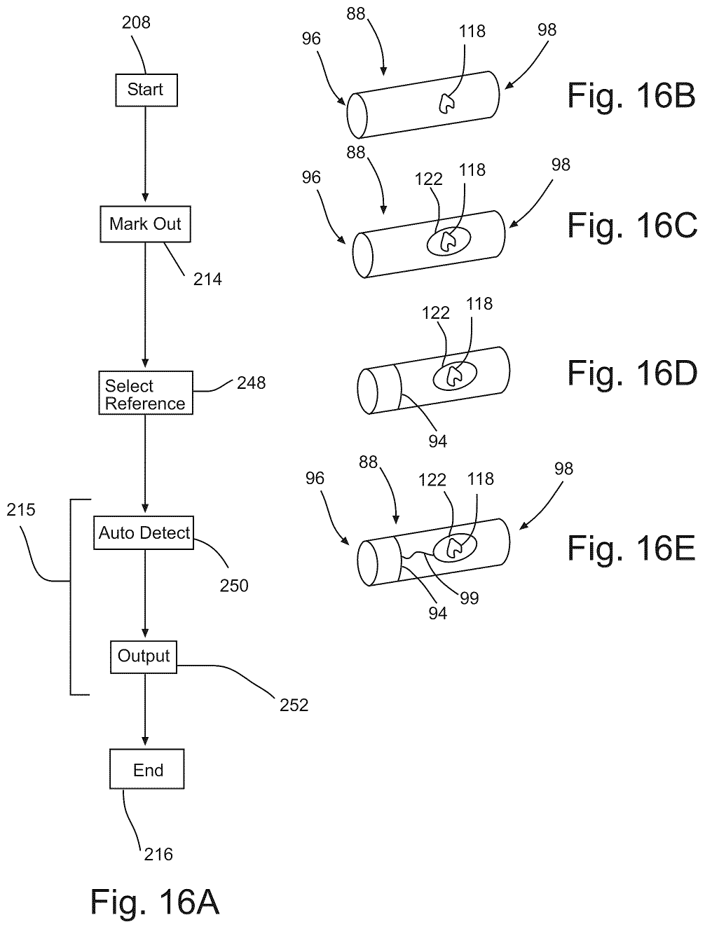

Referring to FIGS. 7-8, 16A-16E, the coordinate information used to create or make up the map data may be measured relative to a defined reference, for example a set of references. An example method is shown in FIGS. 16A-E, and may begin with a start stage 208, followed by a stage 214 of marking out the anomaly 118. Next, in a stage 248, a reference may be selected. The reference used to measure the map data relative to may be the same or different as the reference part of the substrate used to calibrate the pen 12. The coordinate information may comprise coordinates, such as plural coordinates that may make up map data 136, measured relative to the defined reference. The defined reference may comprise a reference line 94, point, object, or other feature on the pipeline 88. Pipeline 88 may comprise pre-existing or manually added references lines 94, including lines 94 added by the pen 12 itself. Reference lines 94 or other reference points on a pipeline or other substrate may include visual or physical markers, which may be used to facilitate alignment, orientation, and measurements during construction, inspection, and maintenance activities. Reference lines 94 are typically strategically placed on the pipeline's surface, often at key locations such as bends, junctions, or valve sites, which may be readily locatable by an operator. Reference lines 94 may comprise meter marks on pipelines 88. The processor 66 may be configured to produce the map data 136 relative to the defined reference, such as one or more reference lines 94, points, objects, or features. In a stage 250, the reference may be automatically detected, for example is a line 99 is drawn between the line 94 and the marking 122. In a stage 252, the data corresponding to the anomaly 118, the marking 122, and any reference lines 94 and 99 may be processed and outputted as map data. The position of the marking 122 may be measured relative to the reference line 94, for example by drawing a line 99 from the reference line 94 to the marking 122 using the pen 12. An axial distance 126 from the reference line 94 may allow the system 10 determine the position of the map data 136 on the pipeline 88. The map data 136 may be measured relative to any defined reference, such as GPS (Global Positioning System) data. The method may follow with an end stage (with the understanding that start and end stages in this document do not refer to actual steps where anything is required to be carried out).

Referring to FIGS. 7 and 8, the map data 136 produced may include various measurements. The marking 122 may bound and define the area of interest. The beginning 101 and end 103 of the anomaly 118 may be marked with the pen 12 and recorded. The interlink crack length 134 may be defined as the distance between the beginning 101 and the end 103 of the anomaly. The map data 136 may include an anomaly width 132. The width 132 may be displayed along a circumferential axis 200. The map data 136 may comprise a length 130. The length 130 may be displayed along an axial axis 198. For all aspects recorded in the map data, each aspect may be defined by a series of coordinates, for example x, y, and z coordinate sets, that collectively define the feature. The coordinates may have an absolute location, such as defined by GPS on the surface of the earth, or a relative location, such as defined by an observable and locatable reference.

Referring to FIGS. 7-8 and 16A-16E, as above, the NDT data collection system 10 may be used to recorded map data of an area of interest on a pipeline 88. Prior to the recording of the area of interest, an NDT process may be carried out on the pipeline 88 to identify the area of interest. The area of interest may correspond to a defect in or on the pipeline, such as anomaly 118. After recording of the area of interest, the defect in the pipeline 88, such as anomaly 118, may be repaired. In other cases, the methods may be used on substates other than a pipeline.

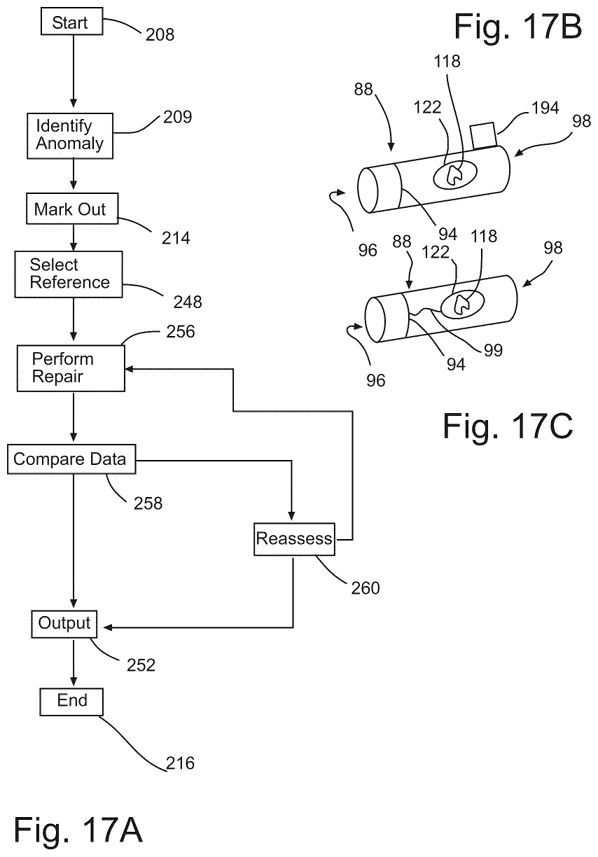

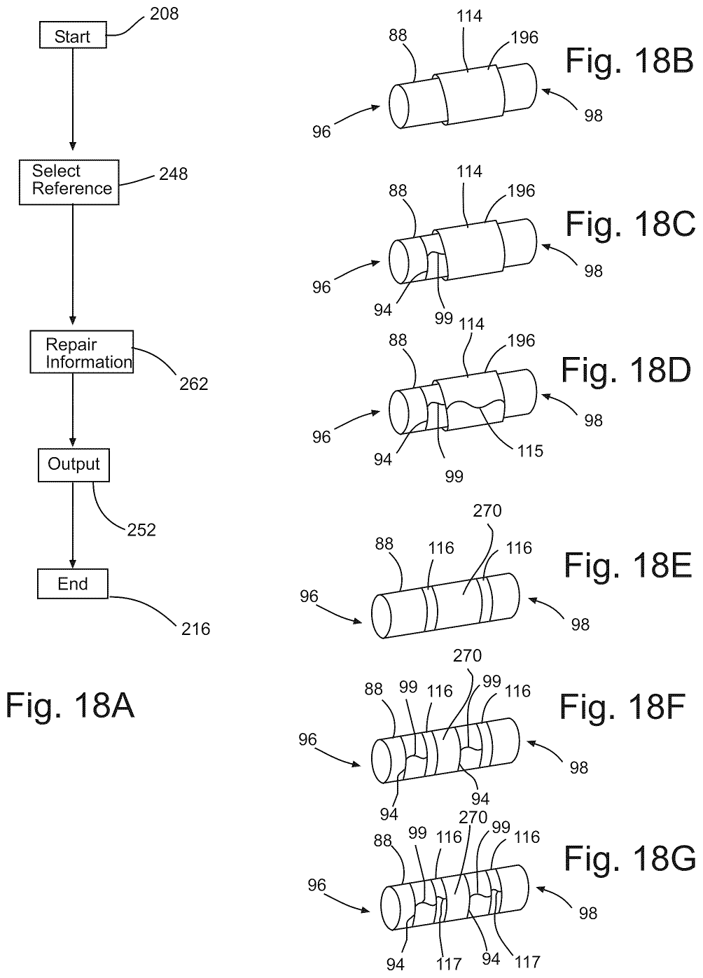

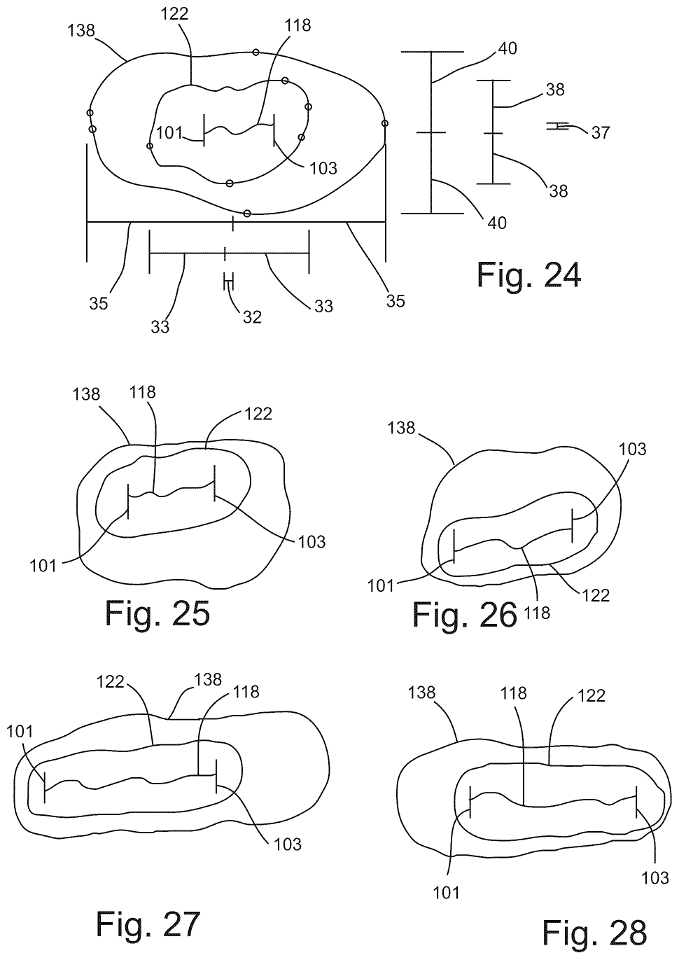

Referring to FIGS. 17A-17C, 18A-18G and 24-28, the system 10 may be used to carry out a repair of the substrate. In some cases, the pen 12 may be used validate the repair of the pipeline 88. The anomaly 118 may be repaired through a variety of methods, such as grinding (FIGS. 24-28), sleeving (FIGS. 18B-18D) and cutting out the damaged section (FIGS. 18E-18G). In the case of a grinding repair (FIGS. 17A-C), after an NDT process (stage 209) and the marking 122 (stages 214-248) has been made around the anomaly 118 with the pen 12, the anomaly 118 may be repaired by grinding, in a series of stages including stage 256. After the grind 138 is complete (stage 256), the grind may be reviewed in a compare data stage 258. The grind 138 may be marked with the pen 12 in a stage 214 so that map data 136 can be compared between the grind 138 and the marking 122 of the anomaly 118. If the map data 136 confirms that the grind 138 completely overlaps the marking 122 of the anomaly 118 then the repair is complete, and the method progresses to output results (stage 252—map data with repair information). If the map data 136 indicates that the grind 138 does not completely overlap the marking 122 of the anomaly 118, then the substrate may be reassessed (stage 260), and if the repair is not complete the method proceeds to a further grinding or repair stage 256 as may be required. In the case of a sleeve repair (FIGS. 18A-D), after the marking 122 has been made around the anomaly 118 with the pen 12, the anomaly 118 may be repaired by sleeving the anomaly 118. After a sleeve 114 is added to the pipeline 88, or in some cases during the data collection stages before the sleeve 114 is added, the pen 12 may be used to draw a line 115 from the reference line 94 to the end of the sleeve 114 so that map data 136 can be compared between the sleeve 114 and the marking 122 of the anomaly 118. If, in a stage 262 the map data 136 confirms that the sleeve 114 is equal to or longer than the length 130 of the marking 122 of the anomaly 118 then the repair is complete. If the map data 136 indicates that the sleeve 114 is not longer than the length 130 of the marking 122 of the anomaly 118, then the repair is not complete and a new and longer sleeve 114 may need to be added. In the case of a cut out repair (FIGS. 18A and 18E-G), after the marking 122 has been made around the anomaly 118 with the pen 12, the user may identify locations 116 for where the anomaly 118 may be cut out from the pipeline 88 and replaced with a new pipe section 270. After or before the new pipe section 270 is installed the pen 12 may be used to draw a line 117 from the reference line 94 to the end of the new pipe section (locations 116) so that map data 136 can be compared between the new pipe section 270 and the marking 122 of the anomaly 118. If in a stage 262 the map data 136 confirms that the new pipe section 270 is equal to or longer than the length 130 of the marking 122 of the anomaly 118, then the repair is complete. If the map data 136 indicates that the new pipe section 270 is not longer than the length 130 of the marking 122 of the anomaly 118, then the repair is not complete and further repairs may be required for a proper repair.

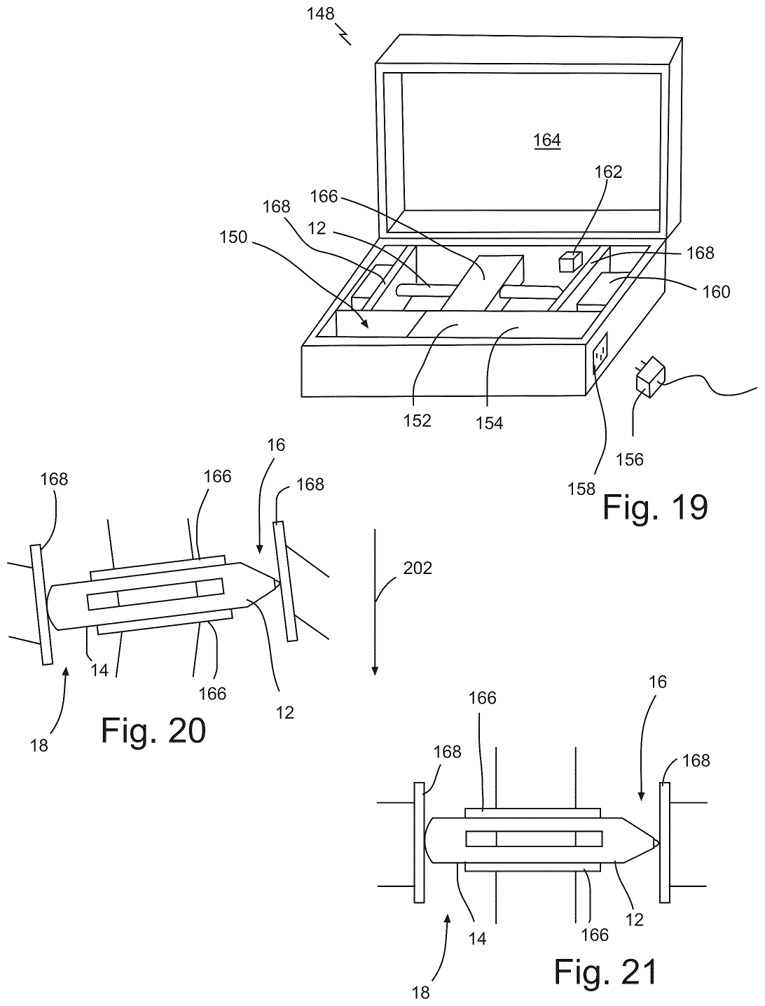

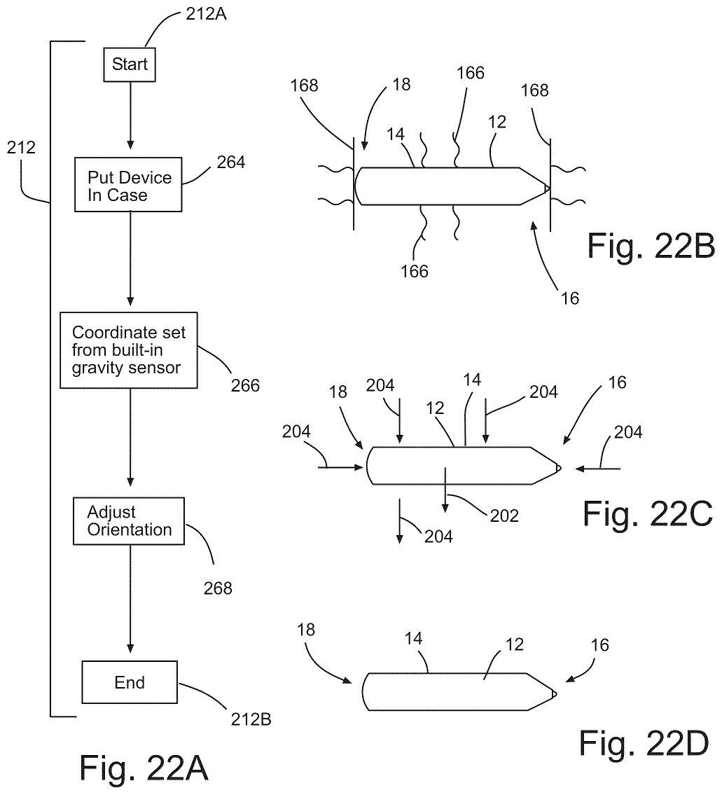

Referring to FIGS. 19-21 and 22A-22D, an example of a portable carrying case 148 is disclosed. The case 148 may define an interior storage compartment 150. The interior storage compartment 150 may comprise a pen holder or mount 166 for the electronic pen 12. The pen mount 166 may be structured to automatically calibrate the pen 12. The mount 166 may hold the pen 12 between opposed plates 168 or parts. The opposed plates 168 may contact the pen 12 at the writing end 16 and the distal end 18. The case 148 may comprise a charging coil 152, which may wirelessly charge the pen 12 through the charging coil 58. The case 148 may comprise a battery 154, which may be charged via a charging port 158. The charging port 158 may connect to a power source 156. The case 148 may comprise a protective surface 164, for example a cushion, to protect the contents of the case 148 during transportation.

Referring to FIGS. 19-21 and 22A-22D, the portable carrying case 148 may comprise a calibration system 160 for the pen 12. The system 160 may carry out a suitable calibration method (stage 212) or part thereof. After a start stage 212A, in a stage 264 the pen 12 may be placed in the case. In a stage 266, the calibration system 160 may determine a coordinate set from a direction of gravity 202, for example using a gravity sensor (not shown). In a stage 268, an orientation of the pen 12 may be adjusted and signals reviewed accordingly. The calibration system 160 may include the opposed plates 168. The calibration system 160 may comprise a mechanism to make mechanical adjustments 204 to the orientation and position of the pen 12 and detect feedback from the position sensor(s). The calibration system 160 may align the pen 12 so that the pen 12 is at a predetermined, angle, such as a 90° angle, relative to the opposed plates 168. The calibration system 160 may allow for the orientation step in the calibrating of the pen 12 to be bypassed, and/or the position step of calibration to by bypassed. The method may conclude in a stop stage 212B.

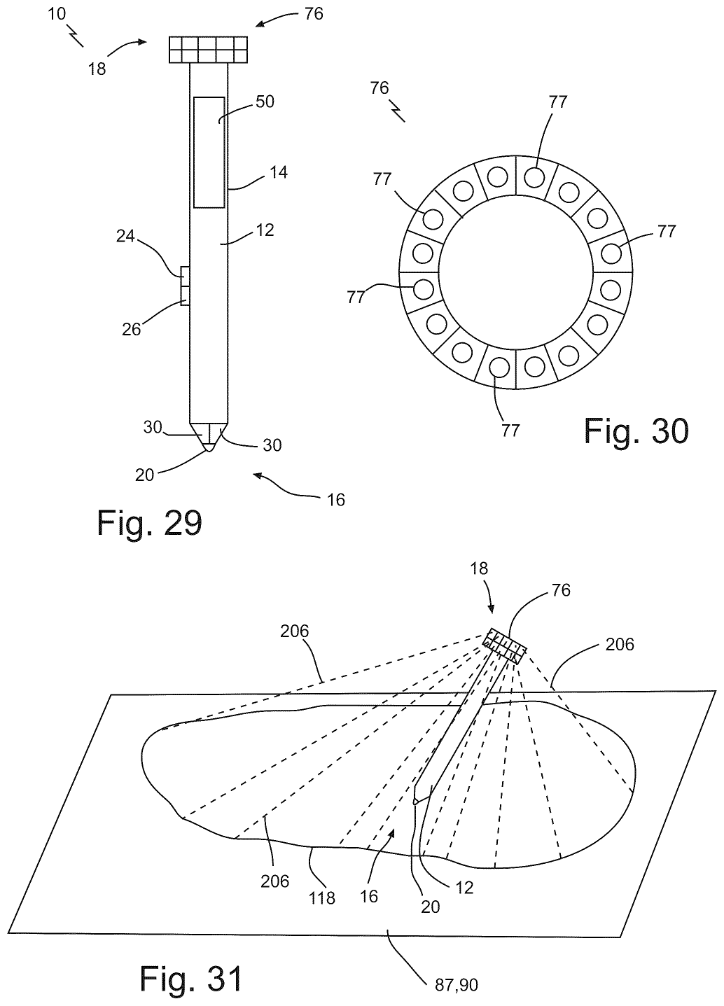

Referring to FIGS. 29-31, the pen 12 may include a camera array 76, for example at the distal end 18 of the pen 12. The camera array 76 may comprise a plurality of individual cameras 77. In the example shown, the array 76 may be arrayed at different angular spacings about a circumference of the pen 12. The cameras may be oriented axially, for example toward the tip 20 of the pen 12. The camera array 76 may be used to take pictures of an area of interest, such as the anomaly 118, while the marking 122 is being made. The field of view 206 of the camera array 76 may be wide enough to capture the entire area of interest. The camera array may be used to photograph the substrate itself, for example during use, in order to capture images from the process itself, and not just of the anomaly. Photogrammetry or other methods may be used to derive information from the substrate, for example the images may be analyzed by the system and measurements deduced from the images, and these measurements may be used to generate the 3D model or otherwise calibrate the system. Artificial intelligence and software may be used to perform the analysis. Images may be combined by the software to yield panoramic images of the substrate. Images may be stored and used, for example to produce a report for the client with a list of the anomalies located, repairs performed, and images of the substrate. The processor may be used to input, compile, or detect dimensional features of the substrate, such as diameters, pipe thicknesses, lengths, and other information. The processor may associate the map data with such dimensional features. For example, the processor may create the 3D model and overlay the map data on the 3D model, or otherwise store the map data with references to the 3D model so the user can view the map data by reference to the dimensional features. A dimensional feature may be any aspect of the substrate that has a measurable dimension, such as a cylindrical section of pipeline. The processor may compile or detect the dimensional features by accessing a database of dimensional features. The processor may compile or detect the dimensional features by analyzing one or more images of the substrate or dimensional features.

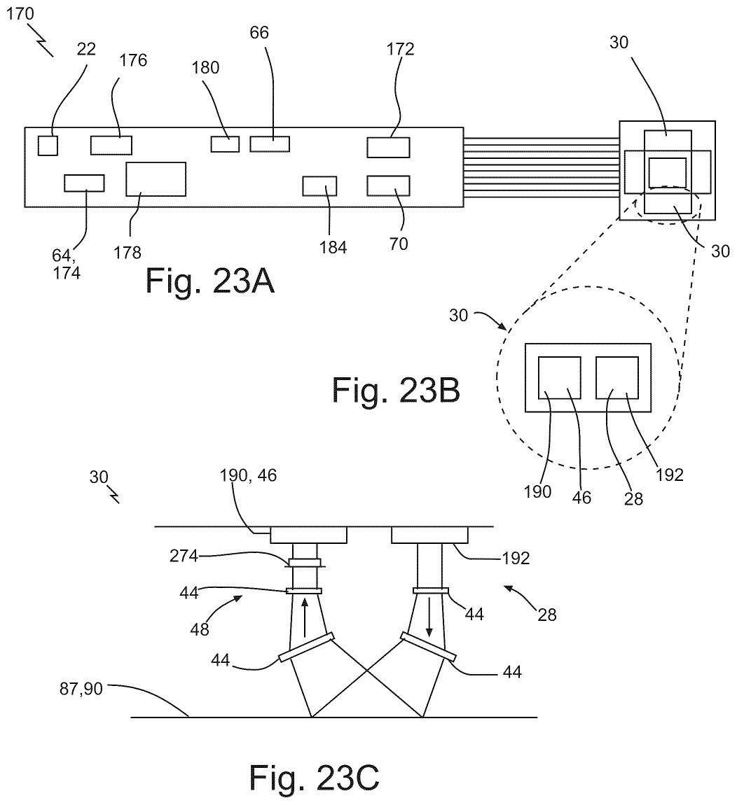

Referring to FIGS. 23A-23B, the pen 12 may include various circuits and circuitry parts to carry out the disclosed functions and methods. An example of a printed circuit board (PCB) 170 for the pen 12 is shown. The PCB 170 may include one or more of a switch 172, USB (universal serial bus) module 176, DSP (Digital Signal Processor) 180, wireless transceiver module 174, storage 178, processor 66, 3D-accelerometer 184, gyroscopic module sensor 70 and a plurality of optical sets 30. The USB module 176 may be used for connection and data transfer between the system 10 and an external computer. The wireless transceiver module 174 may be used when the control panel 50 is external to the pen 12. The 3D-accelerometer 184 may be used for axial and circumferential calibration. The gyroscopic sensor 70 may be used for angular and orientation measurement. The optical sets 30 may include VCSEL (vertical-cavity surface-emitting laser) 192 as light source 28 to provide better results. The optical sets 30 may include CMOS (Complementary metal-oxide-semiconductor) 190 as a light sensor 46 for capturing digital signal. Optical lens sets 30 may shine the laser light source 28 on the substrate 87, such as the surface 90 of a pipeline 88, at an angle smaller than 45°.

The system may produce a report for the user, for example using a template for a report pre-generated in the system and autogenerated after collecting the data. The processor may be used to determine a repair strategy for the anomaly and associate the map data with information on the repair strategy. The system may use artificial intelligence to suggest repair decisions, for example based on industry standards or user-entered preferences for such decisions, to assist the user. The repair strategy may be provided as a single suggestion, or as a plurality of suggested approaches.

The carrying case with calibration function may be made for calibration before use and charging with the case orientation calibration could be omitted.

In some cases, the methods and apparatuses may be used for comparison between repair and anomaly. Various calculation logic may be used to calculate anomaly information. Pre-marking, a system is set by calibration. 6 or 8 points may be selected for calculation of Axial Distance, Orientation, Length, Width, Interlink Crack Length and other information. The points may be under the system, the start of the reference line, the start of the mark, the end of the mark, the highest of the mark, the lowest of the mark, the center of the mark, the start of the anomaly, the end of the anomaly. For a Grinding Repair, information of grinding and anomaly may be compared to ensure the anomaly got fully repaired. The information of the anomaly may be recorded as following: Axial Distance=|Reference start−Mark Start|. Length=|Mark End−Mark Start|. Orientation=Orientation at Mark Centre. Width=|Highest Mark−Lowest Mark|. Interlink Crack Length=|Anomaly End−Anomaly Start|. The Orientation may be set and the distance calculated between the grind orientation point and original anomaly orientation point in circumferential direction: Y1=| (Orientation2−Orientation1)/360*PI*Diameter of Pipe|. The Axial Distance of the grind and the original anomaly may be set and the distance calculated between the center of the grind and the original anomaly: X1=| (Axial Distance of Grind+X22)−(Axial Distance of Anomaly+X11)|. If the center of the anomaly is higher than associated grind, the following dimensions may be compared: [Y11+Y1, Y22]; [Y11-Y1, Y22], Y22 has to be larger or report reassess. If the center of the anomaly is lower than associated grind, the following dimensions may be compared: [Y22−Y1, Y11]; [Y22+Y1, Y11], Y11 has to be smaller or report reassess. If the center of the anomaly is at left of associated grind, the following dimensions may be compared: [X22−X1, X11]; [X22+X1, X11], X11 has to be smaller or report reassess. If the center of the anomaly is at right of associated grind, the following dimensions may be compared: [X11+X1, X22]; [X11−X1, X22], X22 has to be larger or report reassess. The same logic may be used for other repairs.

Table of Parts:

```
  10 system
  12 electronic pen
  14 cylindrical body
  16 writing end
  18 distal end
  20 writing tip
  21 tip contact sensor
  22 power switch
  24 writing switch
  26 sensitivity dial
  28 laser light source
  29 position sensor
  30 optical sets
  31 x axis
  32 X1
  33 X11
  35 X22
  36 y axis
  37 Y1
  38 Y11
  40 Y22
  41 z axis
  44 lens
  46 light sensor
  48 optical detector
  50 control panel
  51 pen clips
  52 screen display
  54 buttons
  56 external housing
  58 charging coil
  60 battery
  62 computer readable medium
  64 Bluetooth transceiver
  66 processor
  68 picture processor
  70 gyro sensor
  72 pressure sensor
  74 ink tank
  76 camera array
  77 individual cameras
  78 pen axis
  80 calculated point
  82 collected point
  87 substrate
  88 pipeline
  90 pipeline surface
  92 pipeline axis
  94 reference line or point
  96 start of pipe
  98 end of pipe
  99 line from ref line to marking
  16 writing end
101 start of anomaly mark
102 girth weld
103 end of anomaly mark
104 Nominal pipe size (NPS)
106 Nominal wall thickness (NWT)
110 longseam
112 Bare Pipe length
114 Sleeve
115 line drawn on sleeve
116 Cut out location
117 line on cut out
118 Anomaly
122 marking around anomaly
124 angular orientation (angle between device and xy plane)
125 projected location of the pen body in the xy plane
126 axial distance from reference line
127 angular orientation (angle from x axis in the xy plane)
130 length of marking
132 width of marking
134 interlink crack length
136 map data
138 Grind
144 Software interface
146 3D model of pipe
147 table of map data
148 Case
150 interior storage compartment
152 Wireless charging
154 Battery
156 power source
158 Charging port
160 Calibration system
162 Gravity sensor
164 Protective cushion
166 pen mount / holder
168 opposed plates
170 PCB
172 Switch
174 wireless transceiver
176 Usb module
178 Storage
180 DSP
184 3D accelerometer
190 CMOS
192 VCSEL
194 NDT testing tool
196 repaired section of pipeline
198 axial axis
200 circumferential axis
202 direction of gravity
204 mechanical adjustments
206 camera field of view (FOV) lines
208 start stage
209 NDT process
210 A/B start/end stages
210 input pipeline info
212 A/B start/end stages
212 calibration stage
214 marking stage
216 end stage
218 NPS size stage
220 NWT stage
222 Longseam stage
224 barepipe length stage
226 pipeline info stage
228 3D model stage
230 draw along longseam stage
232 draw along girth weld stage
234 coordinate set stage
236 place 0 degrees stage
238 place 90 degrees stage
240 place 180 degrees stage
242 place 270 degrees stage
244 dimension calibration stage
246 orientation calibration stage
248 select reference
250 auto detect stage
252 output stage
256 perform repair
258 compare data
260 reassess stage
262 repair information stage
264 put device in case
266 gravity sensor stage
268 adjust orientation stage
270 new pipe section
274 optical filter
```

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. An NDT (non-destructive testing) data collection system comprising:
an electronic pen;
a position sensor configured to detect a three-dimensional position in space of a tip of the electronic pen; and
a processor configured to receive signals from the position sensor and to output, in use, map data of an area of a substrate traced by the electronic pen.

2. The NDT data collection system of claim 1 in which the position sensor comprises a tip contact sensor.

3. The NDT data collection system of claim 2 in which the processor is configured to produce the map data from signals that corresponds to the tip being in contact or close proximity with the substrate.

4. The NDT data collection system of claim 2 in which the tip contact sensor comprises one or more of a pressure sensor or a proximity sensor.

5. The NDT data collection system of claim 1 in which the position sensor comprises one or more optical tracing sets.

6. The NDT data collection system of claim 5 in which the one or more optical tracing sets comprise a plurality of optical tracing sets arranged at different angular positions about a periphery of the tip of the electronic pen.

7. The NDT data collection system of claim 5 in which the one or more optical tracing sets each comprise:
a laser source;
a lens; and
an optical sensor.

8. The NDT data collection system of claim 1 in which the processor is configured to determine an orientation of the electronic pen in space from signals from the position sensor.

9. The NDT data collection system of claim 1 in which the position sensor comprises one or more of an accelerometer and a gyroscope.

10. The NDT data collection system of claim 1 in which the electronic pen comprises an ink pen.

11. The NDT data collection system of claim 1 further comprising one or more of:
a display configured to display the map data; and
a computer readable medium connected to store the map data from the processor.

12. The NDT data collection system of claim 1 in which:
the signals received from the position sensor comprise coordinate information;
coordinate information comprises coordinates measured relative to a defined reference; and
the processor is configured to produce the map data relative to the defined reference.

13. The NDT data collection system of claim 12 in which the processor is configured to store or display the map data in association with the defined reference.

14. A method comprising recording map data of an area of interest on a substrate using the NDT data collection system of claim 1.

15. A method comprising:
moving an electronic pen one or both over or around an area of interest on a substrate, in which the area of interest comprises an anomaly; and
recording, to a computer readable medium, map data of the area of interest calculated by a processor using signals from a position sensor in the electronic pen.

16. The method of claim 15 in which the substrate comprises a pipeline.

17. The method of claim 15 further comprising one or more of:
prior to recording, carrying out an NDT process on the substrate to identify the area of interest as containing the anomaly; and
after recording, repairing the defect in the substrate.

18. The method of claim 14 in which moving the electronic pen further comprising marking the area of interest with the electronic pen.

19. The method of claim 14 further comprising, before moving the electronic pen one or both over or around the area of interest, calibrating the movement of the electronic pen, by moving the electronic pen over a reference part of the substrate and using the processor to correlate the movement with measured dimensions of the reference part.

20. The method of claim 14 in which, one or more of:
the database is a cloud-based database;
the method further comprises, using the processor, inputting, compiling, or detecting dimensional features of the substrate and associating the map data with such dimensional features;
the method further comprises using the processor, to determine a repair strategy for the anomaly and associate the map data with information on the repair strategy; and
the processor compiles or detects the dimensional features by one or more of:
accessing a database of dimensional features; or
analyzing one or more images of the substrate or dimensional features.
